(19) United States
(12) Patent Application Publication
(10) Pub. No.: US 2006/0007135 A1
(43) Pub. Date: Jan. 12, 2006

(54) Image display device and viewing intention judging device

(76) Inventors: Kazuyuki Imagawa, Toyonaka (JP); Eiji Fukumiya, Toyonaka (JP); Katsuhiro Iwasa, Kadoma (JP); Yasunori Ishii, Ibaraki (JP); Shogo Hamasaki, Hirakata (JP)

Correspondence Address: WENDEROTH, LIND & PONACK, L.L.P., 2033 K STREET N. W., SUITE 800, WASHINGTON, DC, 20006-1021, US

(21) Appl. No.: 11/157,963

(22) Filed: Jun. 22, 2005

(30) Foreign Application Priority Data
Jul. 6, 2004 (JP) 2004-199021

(51) Int. Cl. G09G 5/00

(52) U.S. Cl. 345/156

(57) ABSTRACT

A viewing intention judging device comprises an input image control unit, an operation input unit, an element-image generating/selecting unit operable to generate a user interface element image and to handle selection, a composing unit operable to compose the user interface element image and an inputted image, a display unit operable to display the composed image, a person state acquiring unit operable to acquire information of a person near the display unit, a viewing intention judging unit operable to judge a viewing intention of the person, and an operation control unit operable to control the element-image generating/selecting unit and the operation input unit when a judgment result indicates transit from a state with viewing intention to a state without viewing intention or vice versa.

### BACKGROUND OF THE INVENTION

1. Field of the Invention

A present invention relates to an image display device, which can display an image in a good timing with a viewing intention of a person by detecting the viewing intention of the person with a sensor etc. and elaborating control of a display unit.

2. Description of the Related Art

Conventionally, as a device that detects a person with a sensor and controls a display unit, there has been a device that detects existence of a person with an infrared sensor etc., and controls ON/OFF of a power for the display unit. For example, Reference 1 (Published Japanese patent application H07-44144) discloses a technique of attaching such a sensor in front of a display unit.

According to Reference 1, the sensor detects whether or not a person exists in front of the display unit. When the person does not exist in front of the display unit, the power of the display unit is set to OFF. Moreover, the sensor detects whether or not a distance between the front of the display unit and the person is shorter than a predetermined distance. When the distance is shorter than the predetermined distance, the power of the display is set to ON.

Reference 2 (Published Japanese patent application H11-288259) discloses a technique of detecting a person with a sensor and changing display contents. In other words, when the sensor detects a person, a display device reproduces image data, such as an advertisement. According to the technique, when the sensor detects a person, the display device displays an electronic advertising image that is stored in a storage unit beforehand.

Reference 3 (Published Japanese patent application 2002-123237) discloses a technique of detecting a movement of a person with a shooting device, and displaying an effective image according to the movement of the person. Then, whether or not the person is moving is detected by detecting the position of the person, and a composed image is generated according to a change in the position of the person.

Reference 4 (Published Japanese patent application H11-24603) discloses a technique of detecting, by an eye-direction detecting device, an attention point on a display unit where a person is looking at, and displaying predetermined information (for example, an electronic advertising image etc.) around the attention point.

However, in References 1-3, ON/OFF of the power for the display unit and the display content of the display unit are controlled by the existence/non-existence and motion of a person. Therefore, even when there is no viewing intention (for example, in a case where the person is just passing by), the power for the display unit is switched on and off, or the display content is changed.

Therefore, in an environment (for example, a living room at home, a store, an exhibition hall, etc.) where a person frequently moves near a display unit, ON/OFF of the power or ON/OFF of the power-saving mode is frequently repeated, or the display content is frequently changed. Consequently, against the intension of these References, effect of the power-saving or effect of the image display changing in accordance with the movement of the person can not be obtained.

In Reference 2, image data stored in the storage unit are reproduced. However, if a sensor detects a person in the middle of reproducing, the image data is not reproduced to the last, but going back to the beginning of the image data and the same image data is reproduced again. Since this phenomenon occurs every time when the sensor detects a person, it is hard to think that the original advertising effect can be demonstrated by installing such a device as described in Reference 2 in places where many people pass by (the places are where the advertising effect can be thought generally high).

In an information display device using the attention point as described in Reference 4, information is unilaterally displayed around the attention point; however, the information device does not consider an interface with a person. For example, an operation menu is always displayed around the attention point, and moves in accordance with the movement of the attention point. This situation causes inconvenience on the person when the person wants to look at an image other then the operation menu, since the operation menu hinders the image. In short, it is hard to say that the effective display control is performed.

### OBJECTS AND SUMMARY OF THE INVENTION

An object of the present invention is to provide an image display device, which can display an interface timely in accordance with a viewing intention of a person.

A first aspect of the present invention provides an image display device, comprising: an input image control unit operable to control an input image from the exterior; an operation input unit operable to handle an operation input; an element-image generating/selecting unit operable to generate a user interface element image, and further operable to handle a selection input for the generated user interface element image; a composing unit operable to compose the user interface element image generated by the element-image generating/selecting unit and the input image inputted by the input image control unit, thereby generating a composed image; a display unit operable to display the composed image generated by the composing unit; a person state acquiring unit operable to acquire information on a state of a person near the display unit, the person state acquiring unit being related to the display unit; a viewing intention judging unit operable to judge viewing intention of the person near the display unit according to the information acquired by the person state acquiring unit, thereby generating a judgment result; and an operation control unit operable to control the element-image generating/selecting unit and the operation input unit when the judgment result of the viewing intention judging unit indicates that the viewing intention of the person has changed from a state with viewing intention to a state without viewing intention or when the judgment result of the viewing intention judging unit indicates that the viewing intention of the person has changed from the state without viewing intention to the state with viewing intention.

The term “user interface element image” described in the present specification means a graphical image relevant to a user interface displayed through a display unit, such as an operation menu and a personified computer graphics character.

According to a structure of the present invention, when an audience shows a viewing intention, an interface for operation can be displayed in a good timing; thereby the image display device becomes in a state where operation input is possible. Thus, the image display device having an easy-to-use interface can be provided.

A second aspect of the present invention provides the image display device as defined in the first aspect, wherein the operation control unit releases control that has been exercised over the element-image generating/selecting unit and the operation input unit when the operation input unit has not received the operation input for a predetermined time since a time when the judgment result of the viewing intention judging unit indicates that the viewing intention of the person has changed from the state without viewing intention to the state with viewing intention.

According to a structure of the present invention, in a case where a plurality of audiences exist, if one of the audiences stops operation and the other of the audiences does not perform operation for a certain time, the interface automatically disappears. Therefore, the interface does not disturb viewing of the other of the audiences.

A third aspect of the present invention provides the image display device as defined in the first aspect, wherein the person state acquiring unit acquires information indicating whether a person exists in a predetermined area and whether the person in the predetermined area keeps still, and wherein the viewing intention judging unit judges that the person in the predetermined area is in the state with viewing intention when the information acquired by the person state acquiring unit indicates that the person exists in the predetermined area and further that the person in the predetermined area keeps still.

According to a structure of the present invention, since it can be judged that there is no viewing intention even when a person is just passing near a display unit, the power-saving effectiveness is improved, and the operation screen can be shown effectively.

A fourth aspect of the present invention provides the image display device as defined in the third aspect, wherein the person state acquiring unit further acquires information indicating whether a face of the person in the predetermined area looks toward a predetermined direction, and wherein the viewing intention judging unit judges that the person in the predetermined area is in the state with viewing intention when the information further acquired by the person state acquiring unit indicates that the face of the person in the predetermined area looks toward the predetermined direction.

According to a structure of the present invention, in a case where a plurality of display units exist around an audience, if the audience turns his/her face to a display unit which he/she wants to view, the display unit to which his/her viewing intention is directed is resultantly specified. Therefore, the operation menu can be exactly displayed to the audience.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a functional block diagram of an image display device in Embodiment 1 of the present invention;

FIG. 2 is a block diagram of an image display device in Embodiment 1 of the present invention;

FIGS. 3 (a) and (b) illustrate examples of a display in Embodiment 1 of the present invention;

FIG. 4 is a flowchart of an operation control unit in Embodiment 1 of the present invention;

FIG. 5 illustrates a relationship between a shooting area and a definition area in Embodiment 1 of the present invention;

FIG. 6 is a block diagram of a person state acquiring unit in Embodiment 1 of the present invention;

FIG. 7 is a flowchart of a person state acquiring unit and a viewing intention judging unit in Embodiment 1 of the present invention;

FIG. 8 is a flowchart of a person detecting unit and a standstill judging unit in Embodiment 1 of the present invention;

FIGS. 9 (a) and (b) are illustrations showing frame images in Embodiment 1 of the present invention;

FIG. 9 (c) explains a difference image in Embodiment 1 of the present invention;

FIGS. 9 (d) to (f) explain how the difference image in Embodiment 1 of the present invention is processed;

FIGS. 10 (a) and (b) explain how the difference image in Embodiment 1 of the present invention is processed;

FIG. 11 is a chart illustrating a hierarchy of operation components in Embodiment 1 of the present invention;

FIG. 12 is an external view of an image display device in Embodiment 2 of the present invention;

FIG. 13 illustrates a network structure of an image display device in Embodiment 2 of the present invention;

FIG. 14 shows a relationship between a shooting area and a definition area in Embodiment 2 of the present invention; and

FIGS. 15 and 16 explain a person arrangement example in Embodiment 2 of the present invention.

### DETAILED DESCRIPTION OF THE PREFERRED EMBODIMENTS

Hereinafter, a description is given of embodiments of the invention with reference to the accompanying drawings.

### Embodiment 1

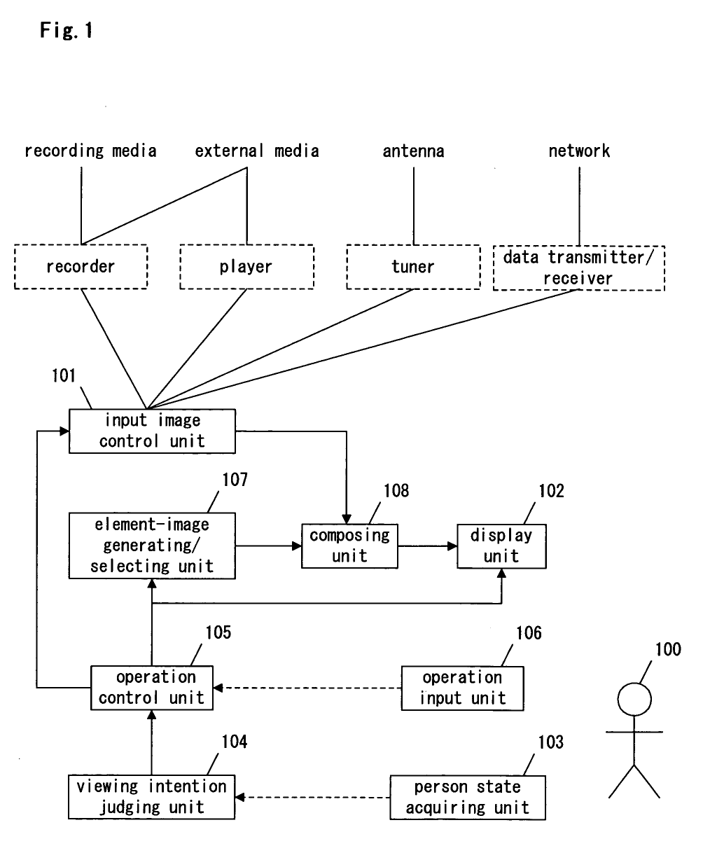

FIG. 1 is a functional block diagram of an image display device in Embodiment 1 of the present invention.

In FIG. 1, an input image control unit 101 inputs an image through a recorder, a player, a tuner, a data transmitter/receiver of a network, etc. A display unit 102 displays the inputted image. In the present invention, it is not necessary to specially distinguish an input path of the image.

A person state acquiring unit 103 comprises one of an infrared sensor, an ultrasonic sensor, a camera, etc., senses a state of a person 100, and outputs information showing the sensed result. In the present embodiment, the following explanation will be focused mainly on the camera, and partly on the infrared sensor and the ultrasonic sensor, when necessary.

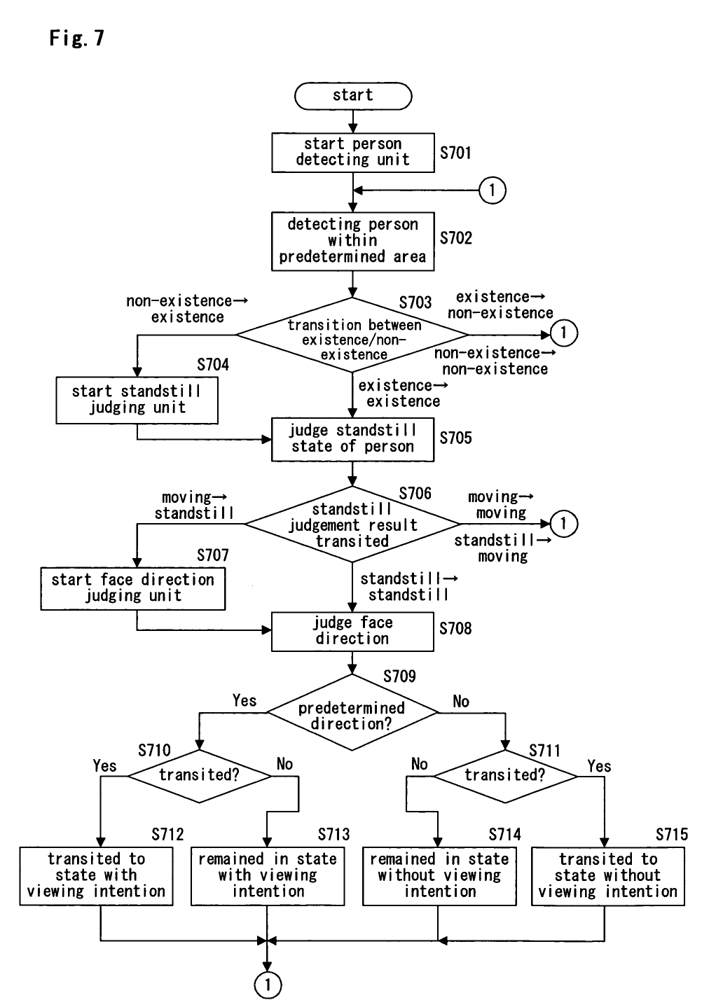

A viewing intention judging unit 104 analyzes the sensed result, such as a camera image, which the person state acquiring unit 103 has acquired. Then the viewing intention judging unit 104 judges whether or not a person exists and the person has a viewing intention. The detail of the viewing intention judging unit 104 is explained later on, referring to FIG. 7 etc.

An operation control unit 105 controls decision, generation, start, end, discontinuation, and resumption of an interface for operation, and controls both an element-image generating/selecting unit 107 and an operation input unit 106, which are mentioned later.

The operation input unit 106 is an element by which a person can actually perform input for operation. Specifically, the operation input unit 106 is constituted by a touch panel operable on the display unit 102, a button, a remote controller operable to remotely control, a portable terminal, etc. The operation control unit 105 controls the operational start/operational end by the operation input unit 106.

In response to an order from the operation control unit 105, the element-image generating/selecting unit 107 generates a screen for a user interface, such as an operation menu and a personified agent (an example of computer graphics characters), and handles a selection of the generated user interface.

A composing unit 108 composes the image that is inputted by the input image control unit 101 and the user interface screen that is created by the element-image generating/selecting unit 107, thereby outputs the composed image. The composed image is displayed on the display unit 102.

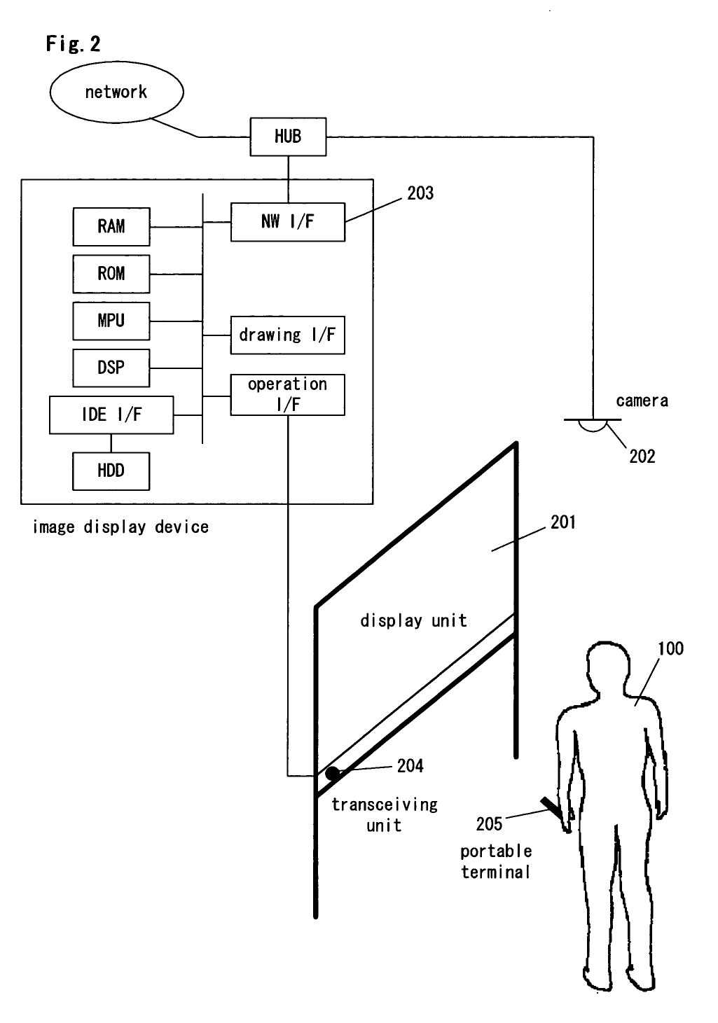

FIG. 2 is a block diagram of the image display device of FIG. 1. A display unit 201 is equivalent to the display unit 102, and is constituted by a display such as LCD, PDP, etc. In the related state to the display unit 201, a camera 202 etc. constituting the person state acquiring unit 103 is arranged. The camera 202 senses the state of a person who is around the display unit 201.

Based on the image inputted with the camera 202, the viewing intention judging unit 104 analyzes existence, movement, a face direction, etc. of a person and judges if there is a viewing intention of the person. Incidentally, the camera 202 and the display unit 201 may be constituted as one piece. Alternatively, the camera 202 and the display unit 201 may be connected through a network. Moreover, the camera 202 and the display unit 201 may not be necessarily related by one-to-one correspondence, but may be related by one-to-many correspondence, or by many-to-one correspondence.

When the viewing intention judging unit 104 judges that there is a new viewing intention based on the information that the person state acquiring unit 103 has acquired, the display contents of the display unit 201 become as follows.

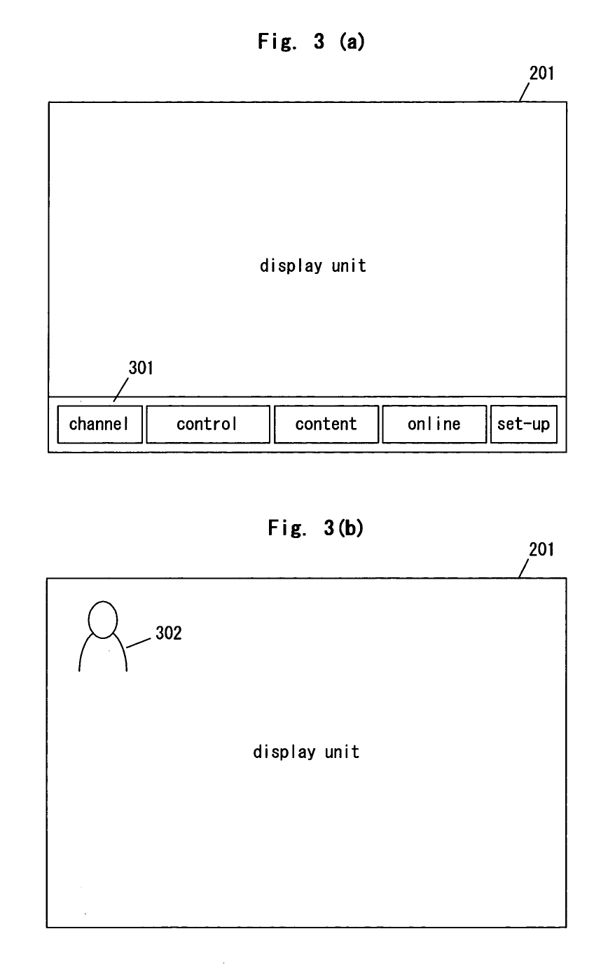

As shown in FIG. 3 (a), the element-image generating/selecting unit 107 chooses a popped-up type operation menu. Then, the operation menu 301 is displayed on the display unit 201. Otherwise, as shown in FIG. 3 (b), the element-image generating/selecting unit 107 chooses a personified agent, and the personified agent 302 is displayed on the display unit 201.

In addition, as shown in FIGS. 3 (a) and (b), it is desirable that the operation menu 301 and the personified agent 302 are superposed on images already displayed on the display unit 201, thereby they are displayed distinctly. It is also desirable that the operation menu 301 and the personified agent 302 are arranged near the edge of the display unit 201.

In addition to the operation menu 301 and the personified agent 302, attribute information of contents (a title, remaining time, a caption, etc.) or other additional information useful for the users (a weather forecast, date, time, etc.) may be displayed simultaneously with or separately from the operation menu 301 and the personified agent 302. Such cases are included in the present invention, as long as the present state can be changed to a state where the operations can be handled.

Moreover, sound volume may be operated simultaneously. For example, it is useful to turn down the sound volume while the menu is displayed in order to let an audience concentrate on the operation more easily. Alternatively, a message may be sounded to encourage the audience to operate.

The operation input unit 106 handles input, such as input by sound input, input by a button or a touch panel (when the display unit 201 can directly detect that an audience touches the panel by a finger) located near the display unit 201, and input by operation on a remote controller or a portable terminal, which is held by or located near a person.

The operation menu 301 shown in FIG. 3 (a) corresponds to the state shown in FIG. 2, and comprises buttons of “channel”, “control”, “contents”, and “set-up.” In the state shown in FIG. 2, the operation control unit 105 sends receivable information to a portable terminal 205 held by the person 100, through a network interface 203 and a transceiving unit 204 and so on. The person 100 controls the display unit 201 using the portable terminal 205.

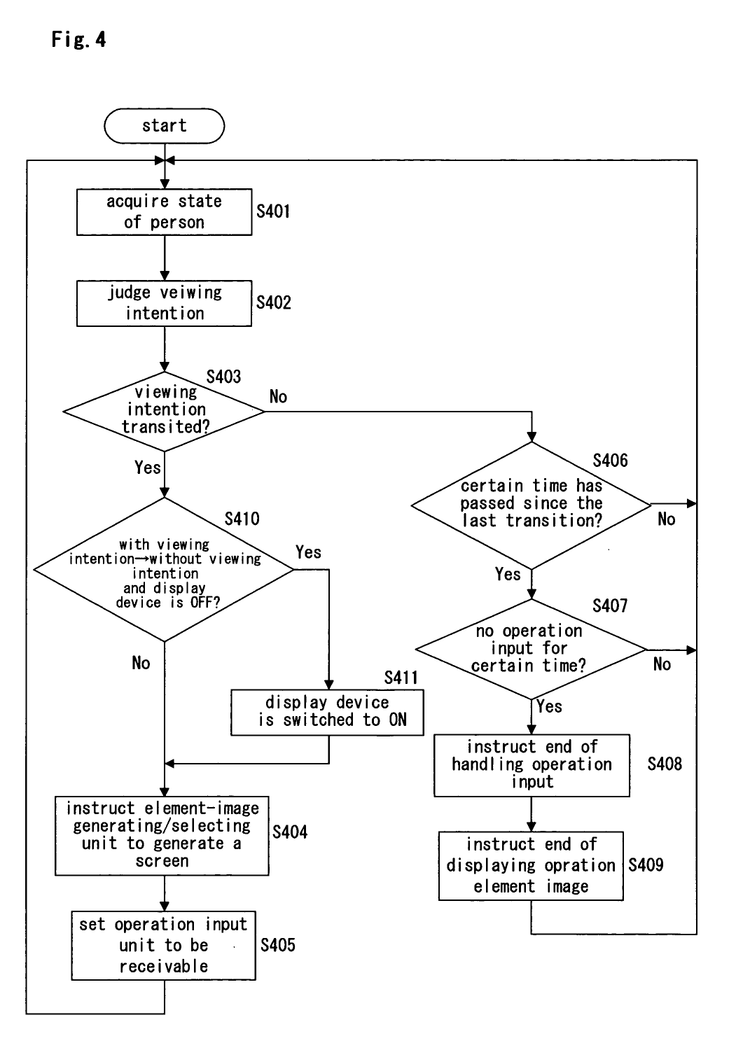

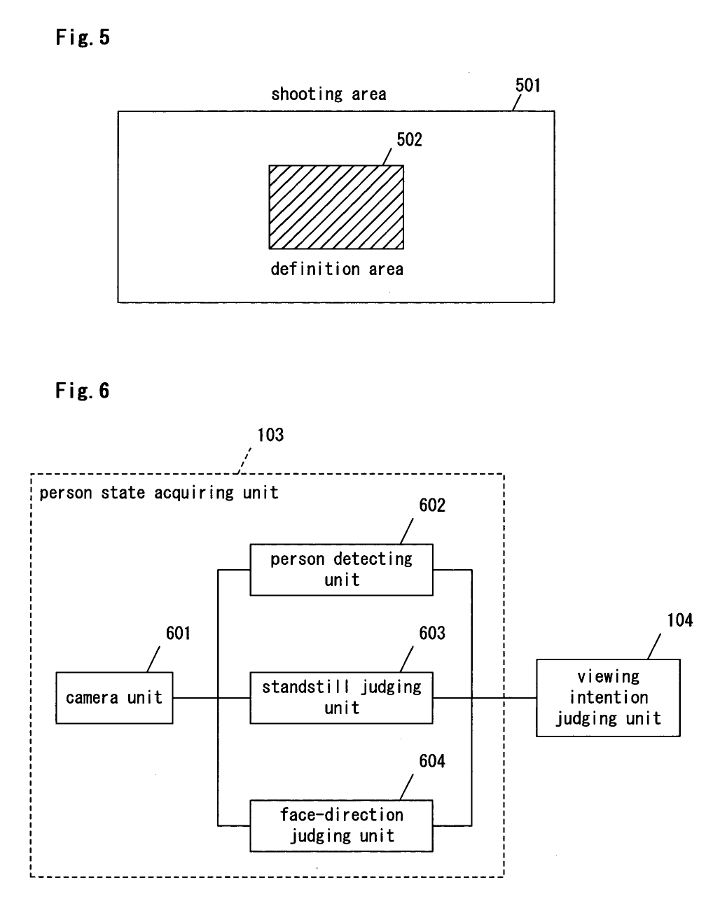

Next, operation of the image display device of the present embodiment is explained, referring to FIG. 4 and FIG. 5. Here, the camera 202 is installed in front of or above the person 100, to detect where the face of the person 100 is.

FIG. 5 illustrates an area which the viewing intention judging unit 104 uses. As shown in FIG. 5, a definition area 502 is set up based on a shooting area 501 of the camera 202. The definition area 502 is an area where the person 100 is regarded as looking at the display unit 201.

In the present embodiment, whether or not a person has a viewing intention is defined as follows. “The state with viewing intention” is a state where the person 100 enters the definition area 502 and then keeps still, with the face of the person 100 turned to the display unit 201; otherwise, it is “the state without viewing intention”.

Next, the flow of processing of the image display device in the present embodiment is explained, referring to FIG. 4.

First, the person state acquiring unit 103 acquires the information of a state of a person (Step S401). The viewing intention judging unit 104 judges whether there is viewer intention, based on the acquired person state acquisition result (Step S402). The operation control unit 105 changes processing to be controlled, based on the result of transition of the viewer intention. (Step S403).

When the state of viewer intention has transited from the state without viewing intention to the state with viewing intention, or from the state with viewing intention to the state without viewing intention, the operation control unit 105 controls the element-image generating/selecting unit 107 to generate a screen, on which operation is performed (Step S404). At the same time, the operation control unit 105 sets the operation input unit 106 ready to handle the operation input (Step S405). When the state transits from the state without viewing intention to the state with viewing intention and a state of the power of the display unit 201 is a first state (the power of the display unit 201 is OFF or the display unit 201 is in a power-saving mode) (Step S410), the state of the display unit 201 is changed to a second state (the power of the display unit is ON or the display unit is in a regular mode) (Step S 411). The composing unit 108 composes the image which the input image control unit 101 inputted and the screen which the element-image generating/selecting unit 107 generated. Then, the composed image is displayed on the display unit 102. The person 100 becomes possible to operate the image display device using the operation input unit 106.

On the other hand, when transition of viewing intention is not confirmed, the operation control unit 105 checks continuously, during a certain period of time after the last transition of viewing intention (Step S406), whether or not there remains no operation input (Step S407).

If the checked result is “yes”, the operation control unit 105 orders the element-image generating/selecting unit 107 to end the operation screen (Step S408), and sets at the same time the operation input unit 106 not-ready to handle operation input (Step S409). Then, the operation control unit 105 returns the processing to Step S401.

If the checked result is “No”, the operation control unit 105 moves the processing to Step S401 immediately.

Next, the person state acquiring unit 103 and the viewing intention judging unit 104 are explained more concretely.

FIG. 6 is a block diagram showing an internal structure of the person state acquiring unit 103. As shown in FIG. 6, the person state acquiring unit 103 comprises a camera unit 601 operable to shoot around the display unit 201 using its optical system, a person detecting unit 602 operable to detect a person from the image shot by the camera unit 601, a standstill judging unit 603 operable to judge whether or not a person is standing still, and a face-direction judging unit 604 operable to judge whether or not the face of a person looks toward the predetermined direction (the direction for the display unit 201).

Next, operation of the person state acquiring unit 103 is explained. First, the camera unit 601 shoots the shooting area 501 shown in FIG. 5. The person detecting unit 602 detects whether or not a person is within the definition area 502. The standstill judging unit 603 judges whether or not the person keeps still. The face-direction judging unit 604 acquires the face area within the definition area 502, and judges whether the face of the person 100 looks toward the display unit 201.

The standstill judging unit 603 does not necessarily judge a state where the body of the person keeps thoroughly still. The standstill judging unit 603 judges the movement of the entire body, or a state where the entire body is moving by such as walking. In other words, the standstill judging unit 603 does not judge whether or not a partial body, such as head or the upper half of the body, is still in action.

Hereafter, using FIG. 7, detailed steps are explained based on the information which the person state acquiring unit 103 has acquired.

First, when the power of the device is turned on, the camera unit 601 and the person detecting unit 602 start (Step S701). The person detecting unit 601 detects whether or not the person 100 exists within the definition area 502 (Step S702).

Next, the operation control unit 105 changes processing based on the transition between existence and non-existence of the person 100 (Step S703). First, when the state of the person 100 transits from non-existence to existence, the operation control unit 105 makes the standstill judging unit 603 start (Step S704). The standstill judging unit 603 judges a standstill state of the person 100 (Step S705). When the person 100 continuously exists in the definition area, the standstill judging unit 603 is already started, and judges that the person is in the standstill state (Step S705). On the other hand, when the person does not exist, the operation control unit 105 moves the processing to Step S702.

When the standstill judgment result of the person 100 indicates that the state of the person 100 has changed from moving to standstill, the operation control unit 105 performs the following processing (Step S706). The operation control unit 105 starts the face-direction judging unit 604 (Step S707). The face-direction judging unit 604 judges whether or not the face looks toward the predetermined direction (Step S708). When the person is continuously in the standstill state, since the face-direction judging unit 604 is already started, the face-direction judging unit 604 judges whether or not the face looks toward the predetermined direction (Step S708). On the other hand, when the person is in the moving state, the operation control unit 105 moves the processing to Step S702.

The face-direction judging unit 604 judges whether or not the face looks toward the predetermined direction (Step S709). The face-direction judging unit 604 judges whether or not the face direction has transited (Step S710 and Step 711). The viewing intention judging unit 104 judges whether the state has transited to the state with viewing intention (Step S712), whether the state remains in the state with viewing intention (Step S 713), whether the state has transited to the state without viewing intention (Step S715), or whether the state remains in the state without viewing intention (step S714). Then, the viewing intention judging unit 104 outputs the result. The information indicating that the state is either one of the four kinds of states is outputted to the operation control unit 105. The operation control unit 105 uses the information for operation control.

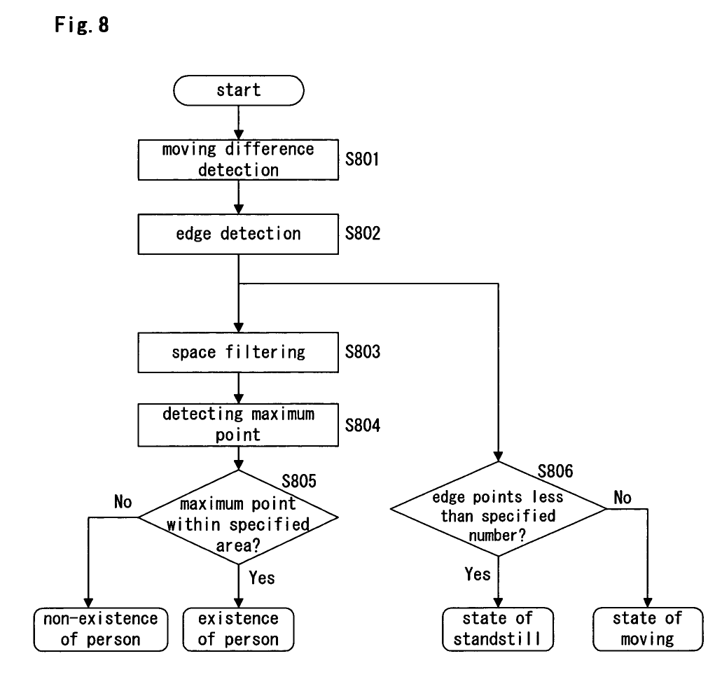

Next, more details of the person detecting unit 602, the standstill judging unit 603, and the face-direction judging unit 604 are explained, referring to FIGS. 6, 8, 9 and 10. FIG. 8 shows the flow of processing of the person detecting unit 602 and the standstill judging unit 603. Both of the person detecting unit 602 and the standstill judging unit 603 perform the moving difference detection (Step S801) and the edge detection (Step S802) in the upper portion of FIG. 8.

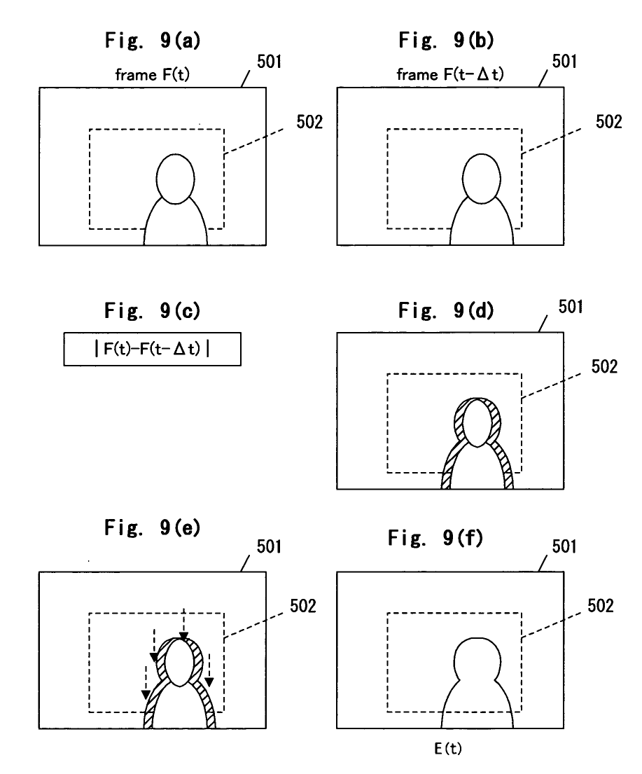

The standstill judging unit 603 obtains two images from the moving image acquired by the camera unit 601. One of the two images is an image F (t) in a marked frame at time t, as shown in FIG. 9 (a). The other is an image F (t-Δt) in a frame at time (t-Δt), Δt before the time t, as shown in FIG. 9 (b).

As shown in FIG. 9 (c), the standstill judging unit 603 obtains an image M(t) (=|F(t)−F(t−Δt)|), which is the absolute value of the difference of the two images defined above (Step S801). As shown in FIGS. 9 (d) to (f), the standstill judging unit 603 searches motion difference points from the upper of the image M(t), and sets edge points, thereby obtaining an edge image E(t) (Step S802). In addition, the standstill judging unit 603 judges that the image F(t) is in the standstill state when the number of the edge points is smaller than the specified number (Step S806).

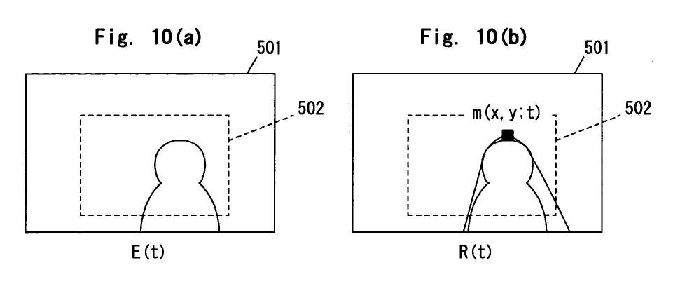

The person detecting unit 602 obtains a ridgeline image (or an envelope image), removing small noises from the edge image. Specifically, the person detecting unit 602 performs the same processing as that of the standstill judging unit 603 from Step S801 to Step S802 as shown in FIG. 10 (a). Then, as shown in FIG. 10 (b), the person detecting unit 602 performs a spatial low pass filter in order to remove the small noises, and obtains a ridgeline image R (t) (Step S803). The person detecting unit 602 regards the ridgeline in the ridgeline image R(t) as a waveform, searches a maximum point of the waveform, and determines a location of the maximum point m (x, y; t) as the position of the person. (Step S804).

Furthermore, the person detecting unit 602 judges whether or not the person 100 exists within the definition area 502. If the person exists within the definition area 502, the person detecting unit 602 judges that the person 100 is at the position where the person 100 can look at the display unit 201 (Step S805).

In addition, the person detecting unit 602 and the standstill judging unit 603 do not have to necessarily use the image that is acquired using the camera unit 601. Instead, the person detecting unit 602 and the standstill judging unit 603 may use a photoelectric sensor or an ultrasonic sensor. For example, when a photoelectric sensor composing a light emitting unit and a light receiving unit is used, a light beam, such as an infrared light beam, emitted by the light emitting unit to the predetermined area is reflected and received by the light receiving unit. The light receiving unit outputs the received light beam as the change in output voltage, output current or a resistance value. If the change is greater than the predetermined value, then it is possible to consider that a person is detected. Moreover, using a plurality of such sensors as an array sensor, the resultant outputs are integrated to judge if a person is in a standstill state.

Alternatively, the person detecting unit 602 and the standstill judging unit 603 may be constituted by suitably selecting other sensing devices in harmony with the environment of set-up. The other sensing devices include such as a pressure sensor, which is buried in the floor surface, an infrared area sensor, a thermal image sensor, a beat sensor, an ultrasonic sensor, etc., the latter three sensors being set on the ceiling.

Next, the face-direction judging unit 604 is explained. The face-direction judging unit 604 judges whether or not the person 100 looks toward the predetermined direction. In order to materialize the judgment system, it may be sufficient to set an infrared light emitting unit on the head of the person 100, and to judge whether or not the infrared light emitting unit is turned to the predetermined direction. The face direction can be judged alternatively by an image of the person 100 that is acquired using the camera unit 601. Thus, the person 100 does not need to wear the infrared light emitting unit, and the face-direction judging unit 604 may be constructed simply. Especially when the camera unit 601 can shoot facial parts of the person, such as eyes, a nose, a mouth, etc., the face direction can be detected, using a template image of the facial parts in the face-direction judging unit 604.

In the present embodiment, all of the person detecting unit 602, the standstill judging unit 603, and the face-direction judging unit 604 input the image shot by the camera unit 601. However, this point is not requisite as mentioned above. While demand for safe and relief increases, the camera unit 601 and the display unit 201 may be separately installed in the physically distant locations. In this case, the camera unit 601 and the display unit 201 may be connected via a network. When people do not come and go in the building where the camera unit 601 is installed, the camera unit 601 can be used as a surveillance camera. Moreover, when people come and go, the camera unit 601 can be used as a component of the person state acquiring unit 103 in the present embodiment. Thus, the camera unit 601 can be used for a different purpose (a surveillance camera) from the purpose in the present embodiment. As long as such a case includes the structure equivalent to the present invention, the case is included in the present invention.

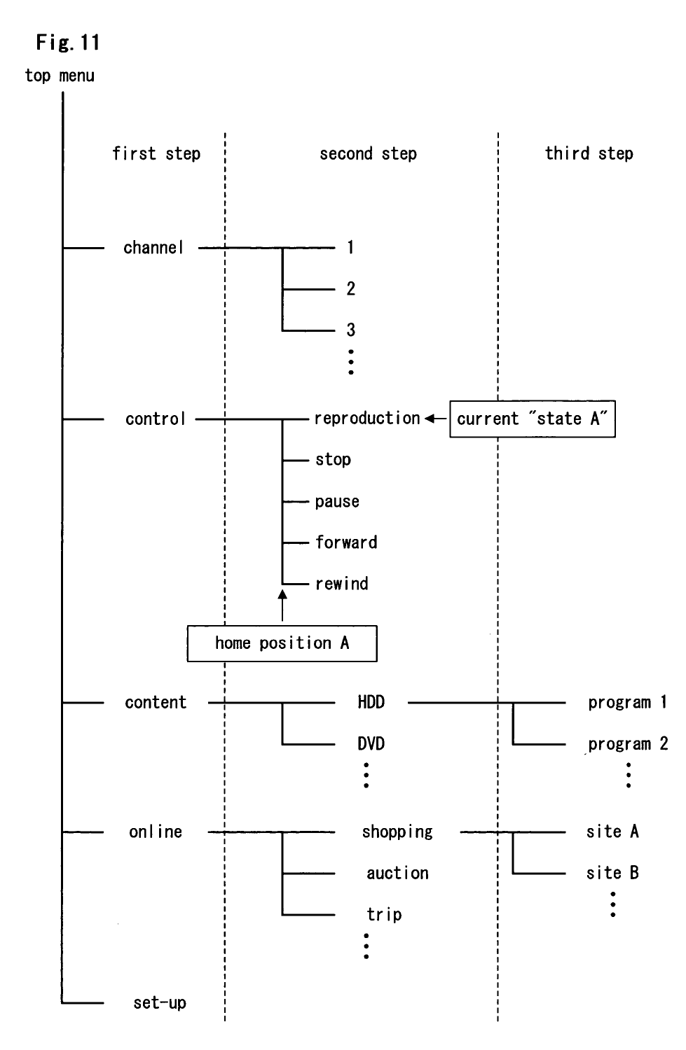

Next, the operation menu 301 (refer to FIG. 3 (a)) possessing the hierarchical structure with a popped-up type, which the element-image generating/selecting unit 107 generates, is explained further in detail referring to FIG. 11. FIG. 11 shows a system of the operation menu.

As shown in FIG. 11, the operation menu provides a system of the multi hierarchical layers, in which selecting a certain item develops the next hierarchical layer. The element-image generating/selecting unit 107 possesses a pointer which points out the item of the hierarchy under execution currently (the current state A). Here, FIG. 11 illustrates a state where a certain madia is currently reproduced.

When the operation control unit 105 requests the element-image generating/selecting unit 107 to generate an operation screen, the element-image generating/selecting unit 107 defines, as a home position, a hierarchical layer that possesses the current pointer as one of options, thereby generating a screen of the position.

For example, in the case of FIG. 11, a menu of “reproduction”, “stop”, “pause”, “forward”, and “rewind”, which are the subordinate items to “control”, is displayed. Alternatively, a top menu may be always displayed, instead of such a home position menu. In a case where a plurality of operation systems are involved complicatedly, it is desirable to adopt the operation system of the home position type in order to improve operability.

On the other hand, in a case of the personified agent 302 shown in FIG. 3 (b), it is possible not only to process for the personified agent 302 to appear, but also to control, according to the state, the movement and expressing of the personified agent 302, and also to control the contents of the voice that the personified agent 302 pronounces (audio data that is reproduced in synchronization with appearance of the personified agent 302).

For example, several patterns of the movement and expression for a moment when the personified agent 302 appears are stored, and one of the several patterns is preferably selected to change the movement and expression, and the contents of the voice, according to the time when the personified agent 302 appears (for example, “Good-morning”, if it is in the morning). Furthermore, even in a case of the personified agent 302, if the current state is managed by the home position type menu, it is advantageous when selecting a word or a series of words, which the personified agent 302 pronounces, or when dynamically changing the voice of the personified agent 302.

As mentioned above, the operation control unit 105 controls the element-image generating/selecting unit 107, and also controls the waiting state of handling the operation input unit 106. Although it is already stated, the input by the operation input unit 106 may be touch panel input, sound input, button input, operation by a portable terminal, and input by a remote controller. Even if any of the input is chosen and used, it is included in the present invention.

### Embodiment 2

Embodiment 1 basically treats one display unit 201 in operation and the operation input thereto and the display thereon are controlled according to the state of viewing intention acquired by at least one camera.

The present embodiment assumes a case where a plurality of display units are used to view image inputted in the input image control unit. In the case, one of the plurality of display units which a person is going to look at is turned ON, and the image is controlled to be displayed on the display unit whose power is ON. Controls necessary for the case are explained as a series of flow from the state when the power is OFF. In the present embodiment, the same names of the elements of Embodiment 1 are given to the elements possessing same functions to those of Embodiment 1.

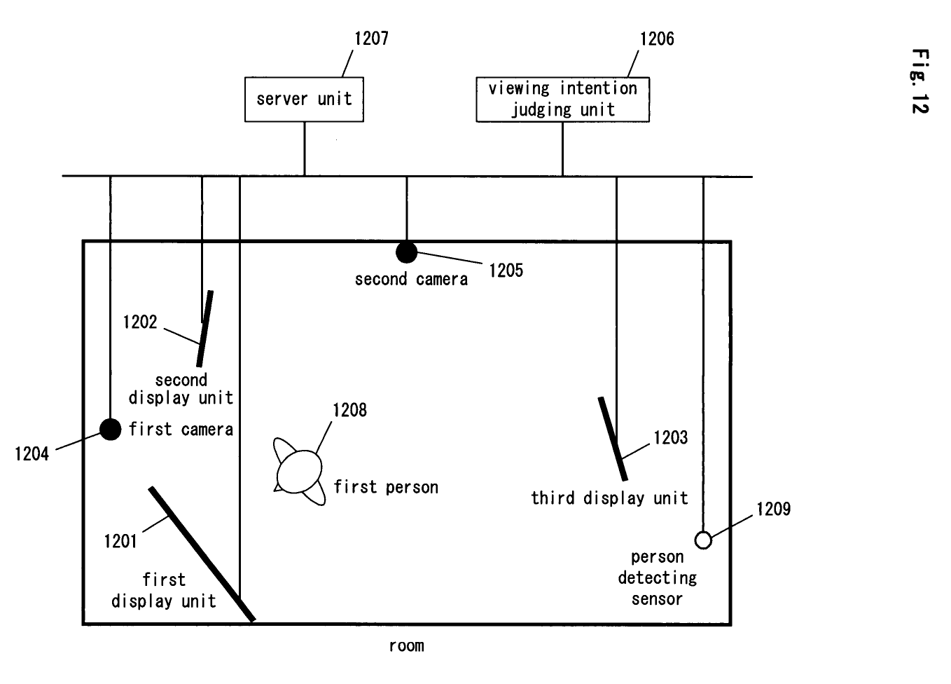

FIG. 12 shows, in plan view, the appearance of the scene where Embodiment 2 is suitable. In a state shown in FIG. 12, there are three display units (a first display unit 1201, a second display unit 1202, and a third display unit 1203) in one room. Two cameras (a first camera 1204 and a second camera 1205) acquire a state of a person, and the display units 1201-1203 are controlled using the acquired state of the person. Moreover, a person detecting sensor 1209 is separately installed to detect whether or not a person is in the room.

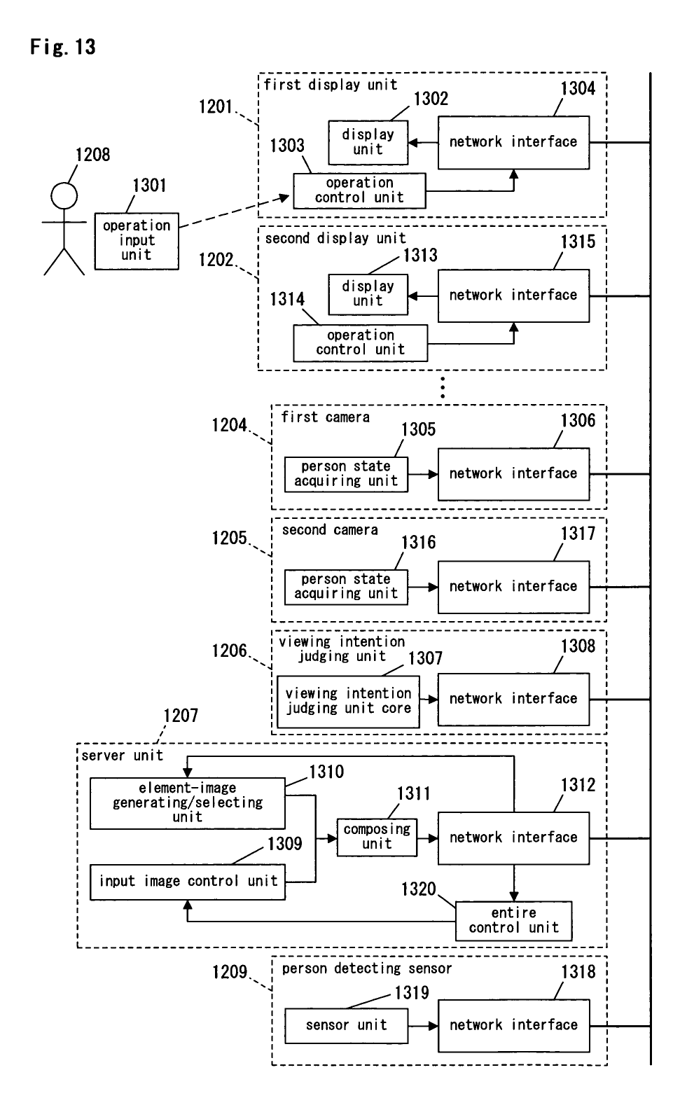

FIG. 13 illustrates a network structure in Embodiment 2 of the present invention. Person state acquiring units 1305 and 1316 connect the cameras 1204 and 1205 with a server unit 1207 via network interfaces 1306 and 1317 respectively. Moreover, in each of the display units 1201 and 1202, the operation control units 1303 and 1314 and the display units 1302 and 1313 connect with the server unit 1207 via network interfaces 1304 and 1315. In addition, the server unit 1207 comprises an entire control unit 1320, which controls the whole device, an element-image generating/selecting unit 1310, an input image control unit 1309, a composing unit 1311, and a network interface 1312. Moreover, as shown in FIG. 13, the person detecting sensor 1209 comprises a sensor unit 1319, and a network interface 1318.

Next, the flow from the state when the power is turned on is explained, referring to FIG. 13. The person detecting sensor 1209 and the cameras 1204 and 1205 are used for a surveillance purpose and a user-interface purpose, switched by the entire control unit 1320 of the server unit 1207.

For example, when a “security-ON mode” is selected by a user via the entire control unit 1320, the cameras 1204 and 1205 are used as cameras and sensors for surveillance. When a “security-OFF mode” is selected, the cameras 1204 and 1205 are used for the purpose of the present invention.

The initial state of the “security-OFF mode” is a “standby mode”. At that time, only the person detecting sensor 1209 and the server unit 1207 are activated. When a person comes in the room, the person detecting sensor 1209 detects the person. Then, the person detecting sensor 1209 notifies, via the network interface 1318, the entire control unit 1320 that the person is detected. As a result, the entire control unit 1320 turns on the cameras 1204 and 1205 and the viewing intention judging unit 1206 (this state is called as a “camera-ON mode”). The cameras 1204 and 1205 acquire a person state. When the viewing intention judging unit 1206 judges that there is a viewing intention, the entire control unit 1320 turns on the power of the display unit to which the viewing intention is directed (either one of the first display unit 1201 and the second display unit 1202), and makes a state of the operation control unit of the display unit waiting for operation input.

In addition, when the person detecting sensor 1209 does not detect a person for a certain time, it is judged that there is no person in the room. Then, the entire control unit 1320 changes the current state to the “standby mode”.

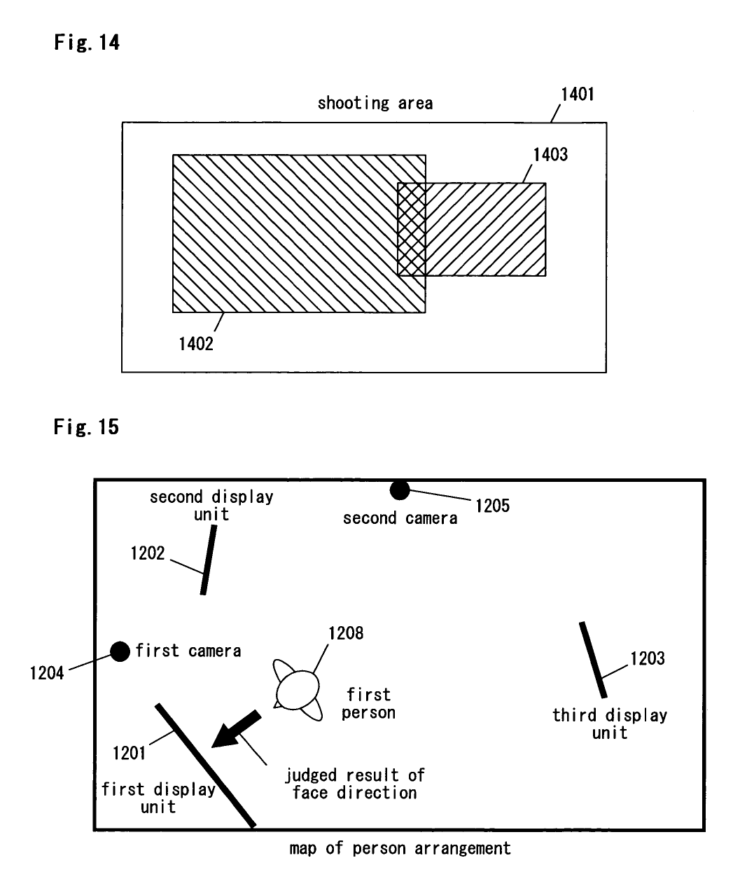

Next, the flow of processing after the “camera-ON mode” is explained using FIG. 12 and FIG. 13. First, the person state acquiring units 1305 and 1316 acquire a person state using the first camera 1204 and the second camera 1205, respectively. As shown in FIG. 14, definition areas 1402 and 1403 in a shooting area 1401 are set to the cameras 1204 and 1205. The definition areas 1402 and 1403 are beforehand defined based on each location of the first display unit 1201 and the third display unit 1203.

The viewing intention judging unit core 1307 performs existence/non-existence judgment, standstill judgment and face direction judgment of the person in the defined area, thereby generating the judgment results, as described in Embodiment 1. The viewing intention judging unit core 1307 further judges that the judgment results correspond to the result of which camera of which display unit. Although the face-direction judging unit assumes that the facial part (for example, eyes, a nose, a mouth etc.) exists in the description of Embodiment 1, face-direction judging in an arbitrary direction is necessary in the present embodiment. The face-direction judging in the arbitrary direction can be realized by the structure described in Embodiment 1 of Published Japanese patent application 2003-44853. For the details, refer to the publication.

The viewing intention judging unit 1206 judges which display unit the person is going to look at, based on the information such as the acquired results of the person state by each of the cameras 1204 and 1205, and the size and direction of the display unit. For this purpose, the viewing intention judging unit core 1307 generates a map as shown in FIG. 15 based on the output from each of the cameras 1204 and 1205. For example, according to the shot result of the first camera 1204, although an image of a person exists and keeps still in both of the definition area 1402 of the first display unit 1201 and the definition area 1403 of the third display unit 1203, the result indicating that the face direction of the person is tuned to the first display unit 1201 is obtained.

Based on the result, the viewing intention judging unit core 1307 judges that the person has a viewing intention to the first display unit 1201, not to the third display unit 1203. The viewing intention judging unit core 1307 turns on the first display unit 1201, and notifies the first display unit 1201 to perform operation control at the same time.

The first display unit 1201, upon notified, makes the state of the operation control unit 1303 ready to handle the operation input by the operation input unit 1301, and requests, via the network, the server unit 1207 to transmit the composed image of the image and the operation element image.

The server unit 1207 receives the request. The composing unit 1311 composes the operation element image, which the element-image generating/selecting unit 1310 has generated, and the image, which the input image control unit 1311 has acquired. The composing unit 1311 transmits the composed image to the display unit 1302 via the network interfaces 1312 and 1304. The first display unit 1302 receives and displays the composed image on the first display unit 1302.

As described above, even in a case where there are a plurality of display units, the first display unit 1202, to which the viewing intention of the person is directed, operates internally the server unit 1207 to acquire the desired result. This operation is performed without especial consciousness of the person. Thereby, the usage of the interface can be remarkably improved.

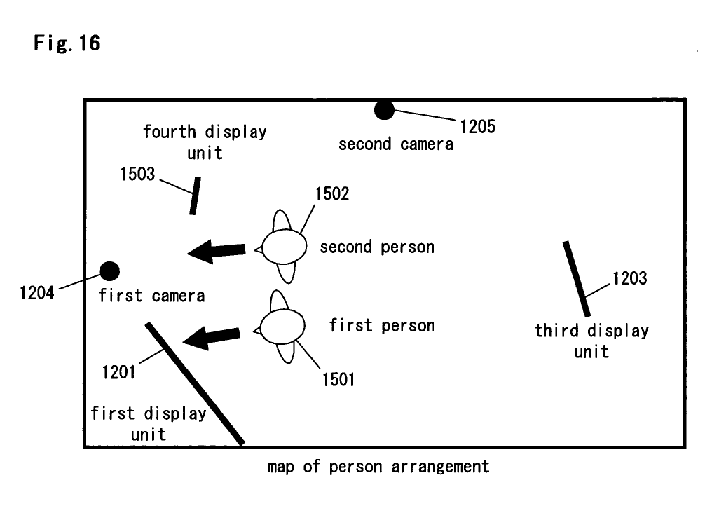

Furthermore, as shown in FIG. 16, in a case where a plurality of persons exist, if it is assumed to select a display unit based on the size of display units and the directions of the persons, it is possible to determine at least one most suitable display unit among the plurality of display units.

For example, in a case where a first person 1501 and a second person 1502 have turned to the direction as shown in FIG. 16, if it is assumed that the nearest display unit to the person is used, the first person 1501 uses the first unit 1201, and the second person 1502 uses the fourth display unit 1503.

However, in the case shown in FIG. 16, if not only the distance between the display unit and the person but also the size of the display unit is considered in controlling, the judgment becomes as follows.

In the state shown in FIG. 16, since the size of the fourth display unit 1503 is extremely small, the definition area of the first display unit is set large corresponding to the large-sized first display unit 1201 and shared by the first person 1501 and the second person 1502; thereby, the first person 1501 and the second person 1502 can use the first display unit 1201. By performing such control, the usage of the interface can be easier and the power consumption can be lowered.

According to the present invention, the interface for operation can be displayed in a good timing when a person shows a viewing intention and the image display unit becomes ready to handle operation input. Therefore, even in a location where a person often moves near the display unit (for example, a living room at home, a store, an exhibition hall, etc.), the operation interface is displayed only when the person shows a viewing intention. In addition, the operation interface does not disturb viewing and listening of other audiences. As a result, unnecessary operation input can be prevented. Furthermore, unnecessary ON/OFF of the display unit can be avoided, thereby the power consumption can be reduced.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An image display device, comprising:
an input image control unit operable to control an input image from the exterior;
an operation input unit operable to handle an operation input;
an element-image generating/selecting unit operable to generate a user interface element image, and further operable to handle a selection input for the generated user interface element image;
a composing unit operable to compose the user interface element image generated by said element-image generating/selecting unit and the input image inputted by said input image control unit, thereby generating a composed image;
a display unit operable to display the composed image generated by said composing unit;
a person state acquiring unit operable to acquire information on a state of a person near said display unit, said person state acquiring unit being related to said display unit;
a viewing intention judging unit operable to judge viewing intention of the person near said display unit according to the information acquired by said person state acquiring unit, thereby generating a judgment result; and
an operation control unit operable to control said element-image generating/selecting unit and said operation input unit when the judgment result of said viewing intention judging unit indicates that the viewing intention of the person has changed from a state with viewing intention to a state without viewing intention or when the judgment result of said viewing intention judging unit indicates that the viewing intention of the person has changed from the state without viewing intention to the state with viewing intention.

2. The image display device as claimed in claim 1, wherein, when the judgment result of said viewing intention judging unit indicates that the viewing intention of the person has changed from the state without viewing intention to the state with viewing intention, said operation control unit makes said element-image generating/selecting unit generate the user interface element image, and said operation control unit sets said operation input unit ready to handle the operation input.

3. The image display device as claimed in claim 1, wherein, when the judgment result of said viewing intention judging unit indicates that the viewing intention of the person has changed from the state without viewing intention to the state with viewing intention, said operation control unit changes a power state of said display unit from a first state to a second state where said display unit consumes more power than in the first state.

4. The image display device as claimed in claim 3, wherein the first state includes at least one of a state where the power is not applied to said display unit and a state of a power saving mode, and
wherein the second state includes at least one of a state where the power is applied to said display unit and a state of a normal mode.

5. The image display device as claimed in claim 1, wherein said operation control unit releases control that has been exercised over said element-image generating/selecting unit and said operation input unit when said operation input unit has not received the operation input for a predetermined time since a time when the judgment result of said viewing intention judging unit indicates that the viewing intention of the person has changed from the state without viewing intention to the state with viewing intention.

6. The image display device as claimed in claim 1, wherein said person state acquiring unit acquires information indicating whether a person exists in a predetermined area and whether the person in the predetermined area keeps still, and
wherein said viewing intention judging unit judges that the person in the predetermined area is in the state with viewing intention when the information acquired by said person state acquiring unit indicates that the person exists in the predetermined area and further that the person in the predetermined area keeps still.

7. The image display device as claimed in claim 6, wherein said person state acquiring unit further acquires information indicating whether a face of the person in the predetermined area looks toward a predetermined direction, and
wherein said viewing intention judging unit judges that the person in the predetermined area is in the state with viewing intention when the information further acquired by said person state acquiring unit indicates that the face of the person in the predetermined area looks toward the predetermined direction.

8. The image display device as claimed in claim 1, wherein said person state acquiring unit includes a shooting unit comprising an optical device.

9. The image display device as claimed in claim 1, wherein the user interface element image generated by said element-image generating/selecting unit includes a graphical user interface according to a structure having an operation hierarchy.

10. The image display device as claimed in claim 9, wherein the structure includes an operation hierarchy when said element-image generating/selecting unit inputs viewing intention from said viewing intention judging unit and an operation hierarchy prior thereto.

11. The image display device as claimed in claim 8, wherein said element-image generating/selecting unit generates a computer graphics character.

12. The image display device as claimed in claim 11, wherein said element-image generating/selecting unit further generates at least one of a motion of the computer graphic character and a countenance of the computer graphic character.

13. The image display device as claimed in claim 12, wherein said element-image generating/selecting unit further generates a voice of the computer graphic character.

14. The image display device as claimed in claim 1, further comprising:
an audio input unit,
wherein said operation control unit controls audio input by said audio input unit.

15. A viewing intention judging device, comprising:
a person state acquiring unit operable to acquire information on a state of a person; and
a viewing intention judging unit operable to judge viewing intention of the person according to the information acquired by said person state acquiring unit, thereby generating a judgment result,
wherein said person state acquiring unit acquires information indicating whether a person exists in a predetermined area and whether the person in the predetermined area keeps still, and
wherein said viewing intention judging unit judges that the person in the predetermined area is in a state with viewing intention when the information acquired by said person state acquiring unit indicates that the person exists in the predetermined area and further that the person in the predetermined area keeps still.

16. The viewing intention judging device as claimed in claim 15, wherein said person state acquiring unit further acquires information indicating whether a face of the person in the predetermined area looks toward a predetermined direction, and
wherein said viewing intention judging unit judges that the person in the predetermined area is in the state with viewing intention when the information further acquired by said person state acquiring unit indicates that the face of the person in the predetermined area looks toward the predetermined direction.
